(19) United States
(12) Patent Application Publication
(10) Pub. No.: US 2024/0266930 A1
(43) Pub. Date: Aug. 8, 2024

(54) APPARATUS FOR MANUFACTURING LAMINATED CORE WITH HEATING ADHESION

(71) Applicant: BMC CO., LTD., Anseong-si, Gyeonggi-do (KR)

(72) Inventor: Seung Soo KIM, Hwaseong-si, Gyeonggi-do (KR)

(73) Assignee: BMC CO., LTD., Anseong-si, Gyeonggi-do (KR)

(21) Appl. No.: 18/566,683

(22) PCT Filed: Nov. 26, 2021
(86) PCT No.: PCT/KR2021/017632

§ 371 Date: Dec. 4, 2023

(30) Foreign Application Priority Data
Jun. 9, 2021 (KR) 10-2021-0074619

(51) Int. Cl. H02K 15/02; B32B 37/12; H01F 41/02

(52) U.S. Cl. CPC H02K 15/022; B32B 37/1207; H01F 41/0233; B32B 2457/00

(57) ABSTRACT

The apparatus for manufacturing a laminated core with heating adhesion according to the present invention is characterized by comprising a lower die 10 comprising a plurality of piercing dies 11, an adhesive applying unit 12 installed on one side of the piercing dies 11, and a laminating unit 13 installed on one side of the adhesive applying unit 12; an upper die 20 comprising piercing punches 21 arranged above the piercing dies 11 and a blanking punch 22 arranged above the laminating unit 13; and an SB steel strip 102 continuously fed to an upper part of the lower die 10, for being formed into a laminar member 101 by operation of the piercing punch 21 and the blanking punch 22, wherein the laminating unit 13 comprises a blanking die 131, a squeeze ring 132 installed at a lower part of the blanking die 131, and a first heating unit 135 installed at a lower part of the squeeze ring 132, and laminates the laminar member 101 in the inner diameter surface of the squeeze ring 132 to manufacture a laminated core 100.

### TECHNICAL FIELD

The present invention relates to an apparatus for manufacturing a laminated core which is a main component for a rotor or a stator of a motor. More specifically, the present invention relates to an apparatus for manufacturing a laminated core with heating adhesion, capable of easily separating laminated cores when manufacturing the laminated cores using an electrical steel sheet having an adhesive layer formed therein, and preventing a laminated core from being overheated and damaged in a die, and a method for manufacturing the same.

### BACKGROUND ART

In general, a core for a rotor or a stator of a motor is manufactured by continuously processing and stacking thin electrical steel strips by a press. A laminated core for a rotor or a stator can be a complete product only when sheets of the core are firmly bonded with each other. Each sheet of a core is manufactured by processing a strip continuously fed to a press. Each sheet of a core undergoes a piercing process including several steps and a blanking process for removing the shape from the strip, and the thus-blanked sheet of a core is called a laminar member. Laminar members are sequentially stacked in a squeeze ring installed in a blanking die and ejected downward.

Conventional methods for bonding laminar members with each other largely include an embossing method and an adhesion method. The embossing method forms a plurality of embossings on the surface of a laminar member when processing the laminar member, to couple the embossings between the laminar members. The embossing method is known to cause iron loss and low magnetic flux density at the coupled parts of embossing shape and reduce the efficiency of the motor.

The adhesion method applies an adhesive to a strip fed to a press die to bond laminar members with each other using the adhesive when the laminar members are stacked in a blanking process. Japanese Patent Laid-Open No. 2005-269732, U.S. Pat. No. 8,474,129, Korean Patent No. 10-1729289, Korean Patent No. 10-1618708, etc., disclose a technique for manufacturing a laminated core by bonding laminar members employing adhesion. The adhesion method applies an adhesive topically to a laminar member. Thus, when adhesion between laminar members is insufficient, strong bonding between the laminar members can hardly be maintained, which leads to degradation in quality or efficiency of the laminated core.

In order to solve the aforementioned problem, Korean Patent Laid-Open No. 10-2018-0021624, Korean Patent No. 10-1861435, Korean Patent No. 10-1803905, etc., disclose an apparatus for manufacturing a laminated core using an electrical steel sheet having an adhesive layer formed on all over one side of the strip, i.e., a self-bonding electrical steel sheet (hereinafter “an SB steel sheet”). The apparatus has a structure of heating and curing the adhesive layer coated on the SB steel sheet in a die when manufacturing the laminated core using the SB steel sheet.

However, generally, in order to heat cure a coating layer of the SB steel sheet, a high temperature of about 180-250° C. is required. When a die or a laminated core is heated at such a high temperature, thermal expansion occurs, which makes it difficult to design a die in response thereto. In addition, when employing high frequency induction heating as a heating method, heat is concentrated in areas having specific shapes in the laminated core such as areas where magnets are inserted or teeth, which causes part of the product to be burnt.

Meanwhile, Korean Patent Nos. 10-1803905 and 10-1861435 disclose a technique for processing an SB steel sheet into laminar members, stacking and heating the laminar members in a die, and interposing a laminar member having protrusions for separation between products to distinguish a core product from others. According to the method, a laminated core is heated in a die and ejected, and thus the laminar member for separation is adhered to a final laminated core product. As such, a process for separating the laminar member for separation from laminated core products is further required. It is difficult to automate the process, which significantly lowers pro-ductivity, and the laminar member for separation is discarded after separation, which causes loss in the material.

Accordingly, in order to solve the aforementioned problems, the present inventor suggests an apparatus for manufacturing a laminated core with heating adhesion, capable of easily separating laminated core products, regardless of an adhesive coated on an SB steel sheet when manufacturing a laminated core using the SB steel sheet, and also preventing defects in a product caused by heating the SB steel sheet in a die at a high temperature, and a method for manufacturing the same.

### DISCLOSURE OF INVENTION

### Technical Problem

It is an object of the present invention to provide an apparatus for manufacturing a laminated core with heating adhesion, capable of easily separating laminated cores manufactured using an SB steel sheet.

It is another object of the present invention to provide an apparatus for manufacturing a laminated core with heating adhesion, capable of preventing the burning of a laminated core at a high temperature in a press even when manufacturing a laminated core using an SB steel sheet.

It is yet another object of the present invention to provide a novel method for manufacturing a laminated core using an SB steel sheet.

The above and other inherent objects of the present invention may all be easily achieved by the description of the present invention described below.

### Solution to Problem

The apparatus for manufacturing a laminated core with heating adhesion according to the present invention is characterized by comprising a lower die 10 comprising a plurality of piercing dies 11, an adhesive applying unit 12 installed on one side of the piercing dies 11, and a laminating unit 13 installed on one side of the adhesive applying unit 12; an upper die 20 comprising piercing punches 21 arranged above the piercing dies 11 and a blanking punch 22 arranged above the laminating unit 13; and an SB steel strip 102 continuously fed to an upper part of the lower die 10, for being formed into a laminar member 101 by operation of the piercing punches 21 and the blanking punch 22, wherein the laminating unit 13 comprises a blanking die 131, a squeeze ring 132 installed at a lower part of the blanking die 131, and a first heating unit 135 installed at a lower part of the squeeze ring 132, and laminates the laminar member 101 in the inner diameter surface of the squeeze ring 132 to manufacture a laminated core 100.

According to the present invention, the apparatus may further comprise a back pressure unit 14 installed at a lower part of the laminating unit 13, the back pressure unit comprising a back pressure plate 141 for supporting a lower part of a laminated core 100 laminated in the squeeze ring 132; a back pressure cylinder 142 for moving the back pressure plate 141 up and down; and a cylinder rod 143 coupled to a lower part of the back pressure plate 141, moving up and down by the back pressure cylinder 142.

According to the present invention, preferably, the apparatus further comprises a second heating unit 17 installed on one side of the lower die 10, wherein the second heating unit 17 comprises a heating jig 171 for locating the laminated core 100 thereon and an induction heater 172 moving up and down above the heating jig 171, wherein the heating jig 171 comprises a jig body 171A and a heating rod 171B protruding upward from the jig body 171A and passing through the inner diameter of the laminated core 100.

According to the present invention, preferably, the height of the heating rod 171B is higher than the height of the laminated core 100.

The method for manufacturing a laminated core with heating adhesion according to the present invention comprises a piercing process for forming the shape of a laminar member 101 in steps on an SB steel strip 102 sequentially transferred; an applying process for applying an adhesive to the surface of the SB steel strip 102 formed into the shape of the laminar member 101; a blanking process for performing blanking on the SB steel strip 102 to form the laminar members 101 in sheets, and laminating and heating the laminar members 101 to cure the adhesive; and a post-heating process for curing an adhesive layer 101B coated on the surface of the laminar member 101.

According to the present invention, preferably, the post-heating process heats the laminated core 100 by repeating the following steps of induction heating a heating rod 171B of a heating jig 171 passing through the inner diameter of the laminated core 100; and induction heating an upper part and a lower part of the laminated core 100 sequentially.

### Advantageous Effects of Invention

The present invention allows laminated cores manufactured using an SB steel sheet to be separated easily, thereby reducing manufacturing time and production cost. Also, the present invention can prevent the burning of a laminated core at a high temperature in a press even when manufacturing a laminated core using an SB steel sheet and improve shape tolerances such as perpendicularity, concentricity, etc., thereby improving product quality and reducing manufacturing cost.

### BRIEF DESCRIPTION OF DRAWINGS

FIG. 1 is a perspective view illustrating an SB steel strip;

FIG. 2 is a perspective view illustrating a laminar member manufactured from the SB steel strip;

FIG. 3 is a perspective view illustrating a laminated core manufactured by stacking the laminar members;

FIG. 4 is a schematic diagram illustrating an apparatus for manufacturing a laminated core with heating adhesion according to the present invention;

FIG. 5 is a schematic diagram illustrating steps of the operation of a back pressure unit in the apparatus for manufacturing a laminated core with heating adhesion according to the present invention; and

FIG. 6 is a schematic diagram illustrating steps of the post-heating process in the apparatus for manufacturing a laminated core with heating adhesion according to the present invention.

Hereinafter, the present invention will be explained in detail with reference to the accompanying drawings.

### MODE FOR THE INVENTION

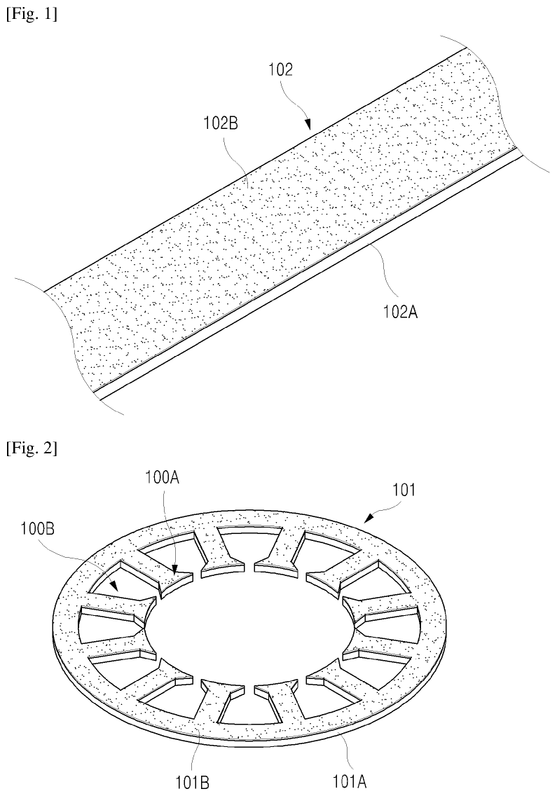

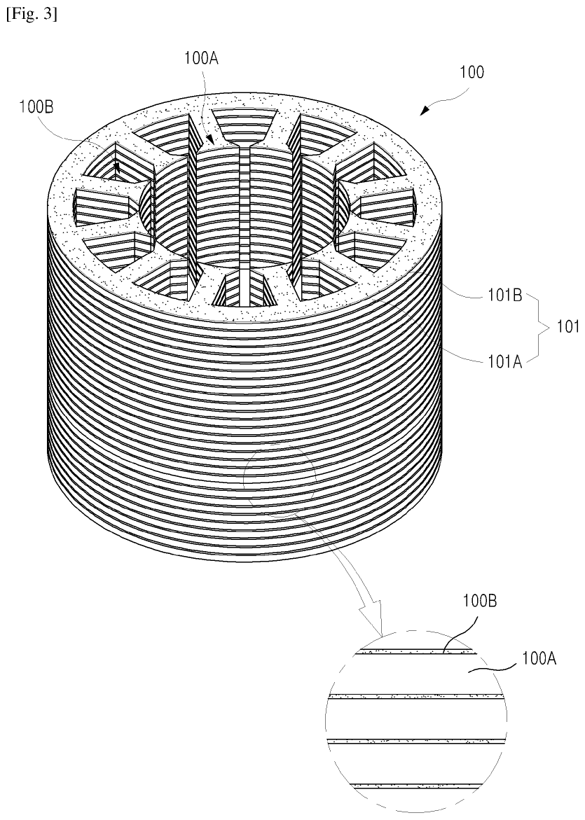

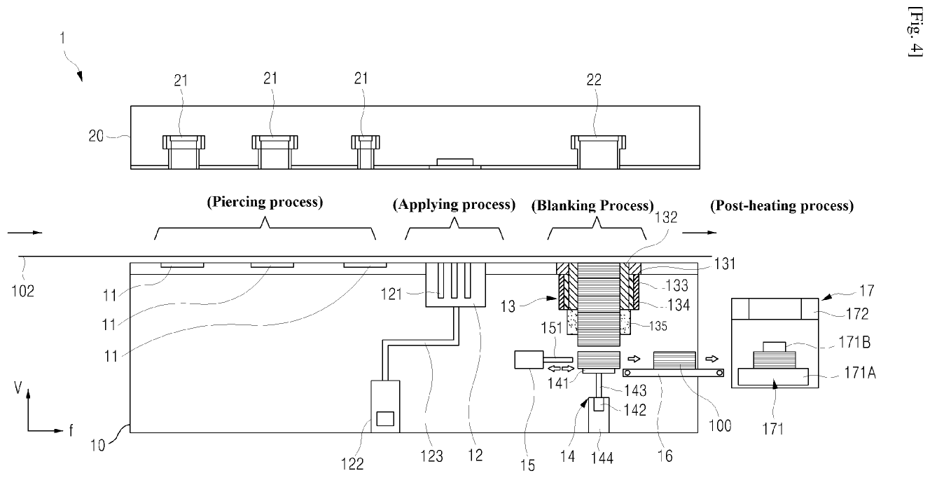

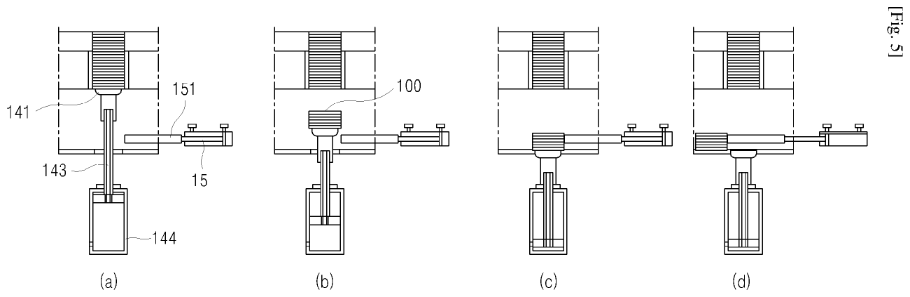

FIG. 1 is a perspective view illustrating an SB steel strip 102; FIG. 2 is a perspective view illustrating a laminar member manufactured from the SB steel strip; FIG. 3 is a perspective view illustrating a laminated core manufactured by stacking the laminar members; and FIG. 4 is a schematic diagram illustrating an apparatus 1 for manufacturing a laminated core with heating adhesion according to the present invention.

Referring to FIG. 1 to FIG. 4 together, the apparatus 1 for manufacturing a laminated core with heating adhesion according to the present invention is a press having a lower die 10 and an upper die 20, and is an apparatus for manufacturing a laminated core 100 by processing through several steps the SB steel strip 102 continuously fed.

The SB steel strip 102 has an adhesive layer 102B where an adhesive is coated on one side of the electrical steel strip 102, as illustrated in FIG. 1. The SB steel strip 102 is continuously fed to the upper part of the lower die 10. The SB steel strip is fed in the direction f in the drawings. The upper die 20 is arranged above the lower die, and is in the direction v in the drawings. The SB steel strip 102 is transferred by one pitch for each process in the feeding direction, and whenever the SB steel strip is transferred by one pitch, the upper die 20 descends to perform press forming on the SB steel strip 102. The apparatus according to the present invention uses the SB steel strip 102 in FIG. 1 to form a laminar member 101 having a core sheet 101A and an adhesive layer 101B in FIG. 2, and laminates laminar members 101 to manufacture a laminated core 100 as in FIG. 3. FIG. 3 illustrates that the laminated core 100 is a stator core having a teeth part 100A and a slot part 100B but is not limited thereto, and the laminated core 100 of the present invention may be a rotor core as well as a stator core.

In the lower die 10, a plurality of piercing dies 11, an adhesive applying unit 12, and a laminating unit 13 are installed in that order in the progress direction (direction f). In the upper die 20, piercing punches 21 corresponding to the positions of the piercing dies 11 and a blanking punch 22 corresponding to the position of the laminating unit 13, are installed.

The number of piercing dies 11 depends on the number of piercing processes. FIG. 4 illustrates an example in which three piercing dies 11 are installed. The piercing punches 21 are installed above the piercing dies 11 to perform piercing sequentially on the SB steel strip 102 passing the upper part of the piercing dies 11.

The adhesive applying unit 12 applies an adhesive to the surface of the laminar member formed in the piercing process. An adhesive applying nozzle 121 contacts the surface of the laminar member and applies an adhesive thereto. The adhesive to be applied is stored in an adhesive supply part 122 installed inside or at one side of the lower die 10. The adhesive is supplied to the adhesive applying nozzle 121 from the adhesive supply part 122 through an adhesive supply path 123 for connecting the adhesive applying nozzle 121 and the adhesive supply part 122, and is applied to the surface of the laminar member.

The laminating unit 13 comprises a blanking die 131 installed below the blanking punch 22 of the upper die 20. A squeeze ring 132 is installed at a lower part of the blanking die 131. The blanking punch 22 punches out a laminar member 101 placed on the blanking die 131 from the SB steel strip 102 by blanking. The laminar member 101 punched out from the SB steel strip 102 by blanking is stacked in the inner diameter surface of the squeeze ring 132 and pushed down by next laminar members sequentially stacked thereafter.

The squeeze ring 132 is installed to be rotatable by a separate rotation driving device (not illustrated). A rotation support part 133 is installed on the side of the outer diameter of the squeeze ring 132 to support the rotation of the squeeze ring 132, and a bearing 134 is installed between the squeeze ring 132 and the rotation support part 133 to allow the squeeze ring 132 to rotate inside the rotation support part 133. When the laminar member 101 is blanked and laminated in the squeeze ring 132, the squeeze ring 132 is rotated such that the laminar members are stacked while rotating at a certain angle to avoid accumulation of process deviations. That is, a laminar member is laminated in the squeeze ring 132 and the squeeze ring 132 is rotated at a certain angle, and then a next laminar member is stacked thereon.

A first heating unit 135 is installed at a lower part of the squeeze ring 132. The laminated core 100 manufactured by stacking laminar members in the squeeze ring 132 and transferred downward is heated at a certain temperature while passing through the first heating unit 135. For the first heating unit 135, various heating means may be used. For example, various heating ways such as induction heating, hot air heating, heating with a heater, etc., may be used. The heating temperature is lower than a temperature at which the adhesive layer 101B of the laminar member 101 is cured. The temperature preferably ranges from about 40 to about 80° C. That is, the first heating unit 135 cures the adhesive applied to the surface of the laminar member 101 by the adhesive applying unit 12, and the adhesive layer 101B of the laminar member 101 is not cured by the first heating unit 135.

The adhesive applying unit 12 and the first heating unit 135 according to the present invention are for smoothly separating laminated cores from each other. That is, when the adhesive is applied to the surfaces of a certain number of laminar members, the adhesive is not applied to specific laminar members. For example, if a laminated core 100 is manufactured by stacking twenty sheets of laminar members, the adhesive is not applied to the first laminar member but applied to from the second laminar member to the 20th laminar member. Similarly, the adhesive is not applied to the 21st laminar member but applied to from the 22nd laminar member to the 40th laminar member. In the same manner, the adhesive is not applied to the 41stlaminar member but applied to from the 42nd laminar member to the 60th laminar member. If the adhesive is applied in this manner and heated, the adhesive is cured, and one laminated core product is ejected while being separated from upper and lower laminated cores thereof with respect to the laminar members to which the adhesive is not applied.

A back pressure unit 14 is installed at a lower part of the laminating unit 13. The back pressure unit 14 supports the lower part of the laminated laminar members 101 or the laminated core 100. To this end, the back pressure unit 14 comprises a back pressure plate 141 for supporting the lower part of the laminar members 101 or the laminated core 100. The back pressure plate 141 is installed on the upper end of a cylinder rod 143 which moves up and down by a back pressure cylinder 142. A cylinder cover 144 is installed at one side of the back pressure cylinder 142 to cover the lower part of the cylinder rod 143.

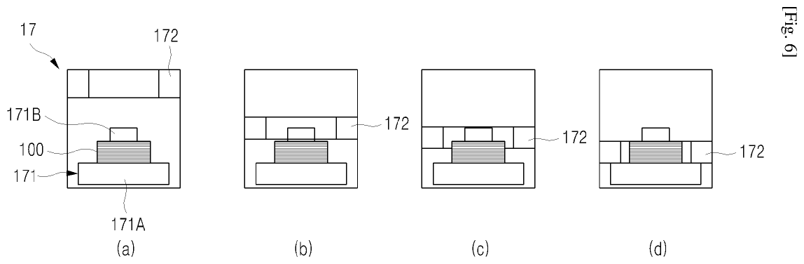

The lower part of a plurality of laminar members stacked in the inner diameter surface of the squeeze ring 132 is supported by the back pressure plate 141. FIG. 5 illustrates the operation of the back pressure unit 14 in detail. FIG. 5 is a schematic diagram illustrating steps of the operation of the back pressure unit 14 in the apparatus 1 for manufacturing a laminated core with heating adhesion according to the present invention.

Referring to FIG. 5, as laminar members are formed by blanking and sequentially stacked, pressure is continuously applied to the lower part. To respond to the pressure, a back pressure plate 141 supports the lower part of the stacked laminar members. FIG. 5(a) illustrates this state. The back pressure plate 141 is installed on a cylinder rod 143 to be movable up and down by operation of a back pressure cylinder 142.

When a plurality of laminar members 101 are stacked to be a laminated core 100, the laminated core passes through a first heating unit 135 and is discharged downward, as illustrated in FIG. 5(b). The back pressure plate 141 descends while loading the laminated core 100 thereon and is placed on one side of an ejection cylinder 15, as illustrated in FIG. 5(c). The ejection cylinder 15 is installed below the laminating unit 13 and operates a pusher 151. The pusher 151 is operated by the ejection cylinder 15 to push the laminated core 100, as illustrated in FIG. 5(d). The laminated core 100 is transferred to a transfer part 16 by the pusher 151. The transfer part 16 transfers the laminated core 100 to a second heating unit 17, which serves as a transfer device like a belt conveyor.

Referring to FIG. 4 again, the second heating unit 17 cures the adhesive layer 101B formed in the laminar member 101 of the laminated core 100. Since the adhesive layer 101B is cured at a relatively higher temperature as described above, if the adhesive layer is heated and cured in the laminating unit 13, thermal expansion may occur in the die or product, and the laminated core may be burnt due to the sudden temperature change. In order to avoid such phenomena, the present invention performs a post-heating process for heating the laminated core at a high temperature in the second heating unit 17 installed on one side of the lower die 10.

The second heating unit 17 according to the present invention comprises a heating jig 171 for locating the laminated core 100 thereon and an induction heater 172 installed above the heating jig 171 to be movable up and down. The heating jig 171 comprises a jig body 171A and a heating rod 171B made of a conductive metal material, protruding upward from the jig body 171A. The heating rod 171B is brought into contact with the inner diameter surface of the laminated core 100. The height of the heating rod 171B is higher than that of the laminated core 100.

The induction heater 172 is installed to be movable up and down, and is preferably a high frequency induction heater. The induction heater 172 directly and indirectly heats the laminated core 100 to heat all parts of the laminated core 100 uniformly and cure the adhesive layer 101B fully. The details are explained with reference to FIG. 6.

FIG. 6 is a schematic diagram illustrating steps of the post-heating process by the second heating unit 17 in the apparatus 1 for manufacturing a laminated core with heating adhesion according to the present invention. As illustrated in FIG. 6(a), a laminated core 100 is located in a heating jig 171, and an induction heater 172 arranged thereabove descends. As illustrated in FIG. 6(b), when the induction heater 172 descends to the upper part of a heating rod 171B, the induction heater 172 operates to heat the heating rod 171B. The heating rod 171B is heated up by induction heating to a certain temperature to heat the inner diameter of the laminated core 100 by heat conduction. Thereafter, the induction heater 172 descends to heat the upper part and the outer diameter of the laminated core 100 sequentially as illustrated in FIG. 6(c) and heat the lower part of the laminated core 100 as illustrated in FIG. 6(d). Then, the induction heater 172 ascends to heat the laminated core 100 and the heating rod 171B again. If the laminated core 100 is heated directly and indirectly in this manner, the laminated core 100 may be heated uniformly at a high temperature without any damages.

Hereinafter, a process for manufacturing a laminated core 100 in the apparatus 1 for manufacturing a laminated core with heating adhesion according to the present invention will be explained in sequential order.

In a piercing process, which is the first process, piercing punches 21 descend to perform piercing on an SB steel strip 102 placed on a piercing die 11. FIG. 4 illustrates three pairs of piercing punches 21 and piercing dies 11, but the number thereof is not limited thereto. That is, three steps of piercing as in FIG. 4 may be performed according to the shape of a laminar member 101 to be processed, and more steps or less steps than that may be performed.

In an applying process, which is the next process, an adhesive is applied to the surface of the laminar member to be formed. An adhesive applying unit 12 is installed on one side of the piercing die 11. The adhesive applying unit 12 may be installed on one side of the piercing punches 21 of the upper die 20 according to needs. The adhesive applying unit 12 comprises an adhesive applying nozzle 121 and an adhesive supply part 122. The adhesive supply part 122 stores the adhesive and is connected with the adhesive applying nozzle 121 through an adhesive supply path 123. The adhesive applying nozzle 121 applies the adhesive topically to the part of the SB electrical steel sheet 102 in which the laminar member 101 is formed when the upper die 20 is at the bottom dead center.

The adhesive used in the adhesive applying unit 12 according to the present invention is a low temperature curing adhesive. The low temperature curing as used herein refers to the properties that the adhesive is cured at a relatively lower temperature at which an adhesive layer 102B formed in the SB steel strip 102 is not cured. As the adhesive layer of the SB steel strip 102 is cured at a temperature of about 180-250° C., the adhesive used in the adhesive applying unit 12 is preferably cured at a temperature of about 40-80° C.

In a blanking process, which is the next process, a laminar member 101 is blanked in a blanking die 131 of the laminating unit 13 and laminated in a squeeze ring 132. The stacked laminar members 101 are heated at a low temperature in a first heating unit 135 at a lower part of the squeeze ring 132, to cure the adhesive applied to the laminar members 101 by the adhesive applying unit 12. When the adhesive is cured, the laminar members are separated into a laminated core 100 while being discharged from the first heating unit 135. The separated laminated core 100 is transferred by a back pressure unit 14 and an ejection cylinder 15 to a second heating unit 17 through a transfer part 16.

In a post-heating process, which is the next process, the laminated core 100 located in a heating jig 171 is heated directly and indirectly by an induction heater 172 which moves up and down. That is, the induction heater 172 heats a heating rod 171B, and the heated heating rod 171B heats the inner diameter of the laminated core 100. Also, the laminated core 100 is directly heated while the induction heater 172 moves up and down. This method may prevent sudden heat shock or deformation, etc. occurring in the laminated core 100.

The present invention is explained in detail as above, and the explanation is provided for illustrative purposes only and the scope of the present invention is defined by the accompanying claims. It should be construed that simple modifications or changes to the present invention fall within the scope of the present invention. Also, although the claims include reference numerals, it is apparent that the applicant does not intend to limit the scope of the present invention thereto.

1. An apparatus for manufacturing a laminated core with heating adhesion, comprising:
a lower die 10 comprising a plurality of piercing dies 11, an adhesive applying unit 12 installed on one side of the piercing dies 11, and a laminating unit 13 installed on one side of the adhesive applying unit 12;
an upper die 20 comprising piercing punches 21 arranged above the piercing dies 11 and a blanking punch 22 arranged above the laminating unit 13; and
an SB steel strip 102 continuously fed to an upper part of the lower die 10, for being formed into a laminar member 101 by operation of the piercing punches 21 and the blanking punch 22,
wherein the laminating unit 13 comprises a blanking die 131, a squeeze ring 132 installed at a lower part of the blanking die 131, and a first heating unit 135 installed at a lower part of the squeeze ring 132, and laminates the laminar member 101 in the inner diameter surface of the squeeze ring 132 to manufacture a laminated core 100.

2. The apparatus of claim 1, further comprising a back pressure unit 14 installed at a lower part of the laminating unit 13, the back pressure unit comprising:
a back pressure plate 141 for supporting a lower part of a laminated core 100 laminated in the squeeze ring 132;
a back pressure cylinder 142 for moving the back pressure plate 141 up and down; and
a cylinder rod 143 coupled to a lower part of the back pressure plate 141, moving up and down by the back pressure cylinder 142.

3. The apparatus of claim 1, further comprising a second heating unit 17 installed on one side of the lower die 10, wherein the second heating unit 17 comprises a heating jig 171 for locating the laminated core 100 thereon and an induction heater 172 moving up and down above the heating jig 171,
wherein the heating jig 171 comprises a jig body 171A and a heating rod 171B protruding upward from the jig body 171A and passing through the inner diameter of the laminated core 100.

4. The apparatus of claim 3, wherein the height of the heating rod 171B is higher than the height of the laminated core 100.

5. A method for manufacturing a laminated core with heating adhesion, comprising:
a piercing process for forming the shape of a laminar member 101 in steps on an SB steel strip 102 sequentially transferred;
an applying process for applying an adhesive to the surface of the SB steel strip 102 formed into the shape of the laminar member 101;
a blanking process for performing blanking on the SB steel strip 102 to form the laminar members 101 in sheets, and laminating and heating the laminar members 101 to cure the adhesive; and
a post-heating process for curing an adhesive layer 101B coated on the surface of the laminar member 101.

6. The method of claim 5, wherein the post-heating process heats the laminated core 100 by repeating the following steps:
induction heating a heating rod 171B of a heating jig 171 passing through the inner diameter of the laminated core 100; and
induction heating an upper part and a lower part of the laminated core 100 sequentially.
